(19) United States
(12) Patent Application Publication
(10) Pub. No.: US 2007/0038578 A1
(43) Pub. Date: Feb. 15, 2007

(54) METHOD AND SYSTEM FOR DIGITAL CONTENT DISTRIBUTION

(76) Inventors: Huizhuo Liu, Fremont, CA (US); Huihui Luo, Wuhan (CN)

Correspondence Address: Huizhuo Liu, 48043 Leontine Ct, Fremont, CA, 94539, US

(21) Appl. No.: 11/161,615

(22) Filed: Aug. 10, 2005

(51) Int. Cl. G06Q 99/00

(52) U.S. Cl. 705/62

(57) ABSTRACT

Systems and methods for distributing digital content from a service provider to users are described. In one aspect, a data partition scheme (methods and systems) is disclosed for a service provider to process and partition digital content into at least two parts: at least one enhancement part and at least one core part. The at least one enhancement part is much bigger than the at least one core part, but is of no or limited value to a user when the at least one core part is missing. The user can only reconstruct and play back the digital content when both the at least one enhancement part and the at least one core part is available. In another aspect, a distribution scheme (methods and systems) is disclosed to distribute the at least one enhancement part and the at least one core part over two separate systems: an enhancement part distribution sub-system built over a peer-to-peer network and a core part distribution sub-system built over a client-server network respectively. According to this scheme, a user acquires the at least one enhancement part through the enhancement distribution sub-system and the at least one core part through the core distribution sub-system, and assembly them to reconstruct and play back the digital content.

### BACKGROUND

Recent development in networking and storage technology has provided versatile ways to distribute digital content such as digital video and audio. Although this offers immense opportunities for content creation, distribution and consumption, digital technology also makes it easy to make perfect illegal copies of copyrighted digital contents. Illegal copying and distribution have posed strong challenge to content distribution system design.

A content distribution system involves multiple parts including the content provider, the distribution service provider and the end users. The end users need easy of use and reasonable price; the content provider is concerned with copyright protection; while the service provider is concerned with the cost of infrastructure, the cost of the digital right management (DRM), and the cost of distribution. A good system should address the needs and concerns of all the parties and achieve a good balance between them. However, most current systems did not do well in this regard.

One common method to distribute digital content is to store content on non-volatile storage media and distribute the storage media to end users. Movies have been distributed on digital video discs (DVD). Blockbuster and Netflix are two companies in DVD rental business. This is not a satisfactory distribution method because producing, managing and shipping DVDs involve a lot of cost. In addition, the DRM technology used in DVD, content scrambling system (CSS), is successfully hacked; and software programs are freely available on the Internet for people to illegally copy and distribute DVD content.

Another common distribution method is to communicate the digital content through an electronic delivery network. This network could be an open computer network such as Internet. It could also be any private networks, for example those cable networks operated by cable companies. Compared with storage media based distribution, network based distribution is more cost efficient and easier to manage since there is no physical media to ship around.

However, the main obstacle with networked delivery is the huge file size normally associated with digital content, and the high bandwidth needed to transfer digital content such as digital video and audio in real time. For example, a typical MPEG-1 movie needs a bandwidth of 1.5 mega bits/second to stream in real time, and a MPEG-2 DVD quality movie needs a bandwidth of 2 to 15 Mega bits/second to stream in real time.

The problem of bandwidth limitation is less an issue for today's cable TV delivery systems because in this type of systems the service provider broadcasts the same set of TV programs to every end user over multiple channels, and each user tunes in to one channel. However, this model is not appropriate for service such as video-on-demand (VOD) since a user can not demand any content that is not broadcasted. In addition, it is difficult to enforce DRM in a broadcast model. In the case of a cable TV system, programs are encrypted and each user can decrypt and get access to only the programs allowed by the DRM information stored in their set top boxes. However, malicious users could crack and make illegal copies of the DRM information of legal users so that they can gain access to content that they never paid for.

Currently, companies such as Movielink and CinemaNow are offering movie-on-demand service over Internet. Paid users can download movies from their website and view later on their PCs. The problem associated with this method is the high-band width needed to send large data files to a user within a convenient time. Within current Internet infrastructure, the downloading site can easily experience network congestion when the number of users grows. This problem gets worse if higher quality, HDTV resolution movie is used in the delivery.

One way to solve the problem is to use more servers. European Patent Application 9387021.4 has disclosed a system where buffer servers managed by the VOD system operators are installed in the network. Since the buffer servers are located closer to the network access points of end-users, network congestion problem can be relived. However, this method needs heavy investment in network infrastructure.

Many methods have also been disclosed to build a digital content distribution system over peer-to-peer models. Previously, Internet based peer-to-peer file sharing systems have been used by many to illegally trade and distribute copyrighted digital content. The famous example is Napster method. This method is described in details in PCT Applications WO 01/84799 and WO 02/15035. In a Napster model, a Peer A searching for content “123” contacts a central server. The central search sends back a list of peers who has content “123”. Peer A contacts a Peer B from the list, establishes a direct connection with Peer B and a data transfer is started between them.

In some other typical peer-to-peer systems such as Kazaa and Gnutella, there is no central server to help establish connections between peers. Instead, a Peer A searching for content “123” broadcasts an inquiry message to peers close to it and each peer further passes the message to another. A peer B who has the content “123” will respond so that a connection is established and a data transfer is started between Peer A and Peer B.

The main benefit of peer-to-peer models is that the data transfers are between peers and no central server is involved. Therefore the network traffic is less likely to get congested. However, the problem is that it is extremely difficult to implement DRM when content are delivered from peers to peers.

Several patent applications known in the art have disclosed methods to implement DRM over peer-to-peer model. In U.S. patent application No. 10/336,110, encrypted digital content are transferred over a peer-to-peer network to end users. In order to get access to the digital content, an end user has to authenticate himself to a central server, from which a decrypting key is issued to the end user to decrypt the content. In PCT Application No. WO 2004/100010, a peer has to first authenticate itself to a central server in order to obtain downloading information of where and when to get the requested content data from another peer. After getting the content data, a peer has to contact a licensing server to get the decrypting key to finally get access to the content.

Although these mentioned systems provided some solutions to improve DRM, they share some fundamental problems with most other peer-to-peer based distribution systems. First, in a peer-to-peer system, multiple copies of digital content are stored locally by multiple end users. Even though the digital content could be encrypted and protected by DRM mechanism, it is a risk that a malice user can find ways to crack it and remove the DRM mechanism. In this situation, high quality digital content can be illegally copied and distributed, bringing in huge lost to the content provider. This is the same problem that the DVD based distribution method has. Second, in a peer-to-peer distribution model, by allowing users to get content from other users, a service provider loses its ability to track each user's usage of the content. For example, if a suspicious copy of copyrighted movie is found being illegally distributed, most current peer-to-peer systems can not tell where the illegal copy originated because the same data representing the movie is shared by all the users. A good method to solve this problem is to send customized copy of digital content to each user by adding watermark that embeds each user's identification (ID). This way, if illegal copies of the digital content are found, the embedded watermark can reveal where the illegal copy comes from. However, this is not quite possible under most current peer-to-peer systems as known in the art.

The present invention comes up with a novel idea of data partition that could solve many problems mentioned above.

### SUMMARY OF THE INVENTION

It is desirable to design a content distribution system that keeps the benefits of a typical peer-to-peer network but implements better DRM features.

In one aspect, the inventor proposes a data partition method. A service provider uses this method to process each title of digital content (e.g., a movie), and partition the data representing each title into at least two parts: at least one enhancement part and at least one core part. The partition method has to meet the following criteria: 1) a core part is small in size, but carrying critical information; 2) an enhancement part is much bigger, representing the majority of the information associated with the title, but is of no or limited value to a user when at least one core part is missing; 3) a user can reconstruct the original data associated with the title only when all the core part(s) and the enhancement part(s) are available.

In another aspect, the inventor proposes a scheme (methods and systems) for digital content distribution over on an electronic network. According to this scheme, a content distribution system comprises a partition server, a category server, a dispatch server, a licensing server, one or more client devices, and an electronic network that connects the servers with client devices.

Initially, the partition server processes each title of digital content, and partition the data representing each title into at least two parts: at least an enhancement part and at least a core part. The partition server then sends the enhancement parts to the dispatch server, the core parts to the license server, and the category information to the category server.

A user, through operating a client device, gets a category of the titles of the available digital content from the category server. The user selects a title through a user interface offered by the client device. The client device then gets the at least one enhancement part and the at least one core part of the selected title separately through different channels.

In one embodiment, the client device first checks if the at least one enhancement part of the selected title is on its local storage. If it is, then the client device will skip the enhancement part downloading step. Otherwise, the client device acquires the at least one enhancement part of the selected title over a peer-to-peer network.

In one embodiment, the client device sends its downloading request to the dispatch server. After authenticating the requesting client device, the dispatch server further sends download instruction to the client device. Based on the download instruction, the client device gets the at least one enhancement part of the selected title from the dispatch server and/or from one or more other client devices (other peers) that have the data.

After the enhancement part downloading step, the client device engages in a separate step to download the at least core part of the selected title

In one embodiment, the client device gets the at least core part of the selected title through a client-server model. According to this embodiment, the client device contacts and authenticates itself with the licensing server. The licensing server updates the billing information for the authenticated client device and the associated user, optionally adds digital watermark embedding the client device's identification to the core part(s) of the title being requested, and streams the final data to the client device. The client device assemblies the core part(s) and the enhancement part(s) to recover the digital content requested.

In another embodiment, the at least one enhancement part of the data representing the title the user requested is (are) stored on some non-volatile media (e.g., DVD), and shipped to the user. When the user attempts to access the digital content over a client device, the client device contacts and authenticates itself with the licensing server. The licensing server updates the billing information for the authenticated user, adds DRM information embedding the client device's identification to the core part(s) of the title being requested, and streams the final data to the client device. The client device assemblies the core part(s) and the enhancement part(s) to recover the digital content requested.

The obvious benefits of the scheme proposed by this invention include the following: (a) By using a peer-to-peer network (or using non-volatile media) to distribute the enhancement part(s) of a title, the majority of the data associated with the title (the at least one enhancement part) reaches the client devices of end users very cost efficiently. (b) But at the same time, the risk of illegal copying is minimal because some critical content information (that is necessary for playing back the content) is stored in the at least one core part. Nobody can play back or reproduce the digital content of the title without the at least one core part. (c) Since the distribution of the core part(s) of a title is carried out through a client-server model, it is much easier to implement strong DRM than to do it over a peer-to-peer model. (d) In addition, the cost of implementing the core part(s) distribution infrastructure is not high because the total size of the core part(s) of a title is much smaller than the size of the corresponding enhancement part(s) of the same title. And a service provider does not have to invest heavily in servers and network infrastructure.

### BRIEF DESCRIPTION OF THE DRAWINGS

Features of the present invention will become apparent to those skilled in the art from the following description with reference to the figures, in which:

FIG. 1 is a view showing the typical architecture of a “computing device”.

FIG. 2A is a view showing a structure of a digital content distribution system according to one embodiment of the present invention;

FIG. 2B is a view showing a structure of an enhancement part distribution sub-system according to one embedment of the present invention;

FIG. 2C is a view showing a structure of a core part distribution sub-system according to one embedment of the present invention;

FIG. 3 is an exemplary flow diagram of an embodiment of partition server data processing procedure;

FIG. 4A is a block diagram of an embodiment of an data partition module implemented using a frame filtering algorithm;

FIG. 4B is a block diagram of an embodiment of an data assembly module corresponding to the data partition module depicted by FIG. 4A;

FIG. 4C is a block diagram of an embodiment of an analysis module (used in a data partition module) using Wavelet filter banks.

FIG. 4D is a block diagram of an embodiment of a synthesis module (used in a data assembly module) corresponding to the analysis module depicted by FIG. 4C.

FIG. 4E is a block diagram of another embodiment of an analysis module using stacked Wavelet filter banks.

FIG. 4F is a block diagram of an embodiment of a synthesis module corresponding to the analysis module depicted by FIG. 4E.

FIG. 4G is a block diagram of an embodiment of an analysis module that processes a 2-dimension data input.

FIG. 4H is a block diagram of an embodiment of an synthesis module corresponding to the analysis module depicted by FIG. 4G.

FIG. 5A is a block diagram of an embodiment of an enhancement part processing module with input data being a MPEG-1 video bit stream;

FIG. 5B is a block diagram of an embodiment of a core part processing module with input data being a MPEG-1 video bit stream;

FIG. 5C is a block diagram of an embodiment of a data assembly module for assembling bit streams generated by an enhancement part processing module shown in FIG. 5A and an core part processing module shown in FIG. 5B;

FIG. 5D is a block diagram of an embodiment of a data partition module with input data being a MPEG-1 system bit stream;

FIG. 5E is a block diagram of an embodiment of a data assembly module for assembling bit streams generated by the data partition module shown in FIG. 5D;

FIG. 6 is a flow diagram of an embodiment of an enhancement part download session (client device);

FIG. 7A is a flow diagram of an embodiment of a client side core part session;

FIG. 7B is a flow diagram of a server side core part session;

FIG. 7C is a block diagram of an embodiment of a core part wrapping module;

FIG. 8A is a flow diagram of an embodiment of a client device main process;

FIG. 8B is a flow diagram of an embodiment of a client device play back session;

FIG. 8C is a block diagram of an embodiment of a client device data processing session; and

FIG. 8D is a flow diagram of an embodiment of a client device serving process.

### DETAILED DESCRIPTION OF THE INVENTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

I. Definitions

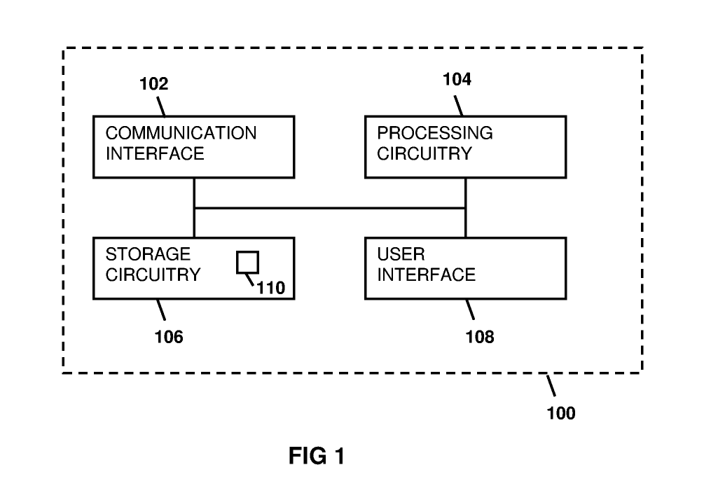

“Computing device” refers to a device includes essentially, as shown by FIG. 1, a communication interface 102, a processing circuitry 104, a storage circuitry 106 and a user interface 108. Communications interface 102 is arranged to implement communications of computing device 100 with respect to external devices (not shown). Processing circuitry 104 may be arranged to process data, control data access and storage, issue commands, and control other desired operations. Processing circuitry may comprise circuitry configured to implement desired programming provided by appropriate media in at least one embodiment. Storage circuitry 106 is configured to store electronic data and/or programming such as executable instructions (e.g., software and/or firmware), data, or other digital information and may include processor-usable media. Storage circuitry may optionally include some non-volatile media such as hard disk or floppy disk 110. User interface 108 is configured to interact with a user including conveying data to a user (e.g., displaying data for observation by the user, audibly communicating data to a user, etc.) as well as receiving inputs from the user (e.g., tactile input voice instruction, etc.).

“Client device” means a computing device operated by a user, with respective user interface, communication interface, storage circuitry and user interface designed for digital content distribution client functions.

“Server” means a computing program that provides some service to other client programs or computing devices. The connection between client and server is by means of message passing over a network, and utilizes protocols to encode the client's requests and the server's responses. On another aspect, a server can refer to a computing device that provides some service for other computing devices connected to it via network. An exemplary computing device is shown in FIG. 1. On some other aspect, the term server can refer to both computing programs and computing devices. The functions of a server can be performed by either a single server or multiple distributed servers.

“Peer-to-peer network” (P2P) means a network relies on the computing power and bandwidth of the participants in the network rather than concentrating it in a relatively few servers. P2P networks are typically used for connecting nodes via largely ad hoc connections. Such networks are useful for many purposes. In this invention, P2P is used for sharing content files. Therefore, a P2P network could be a pure peer-to-peer file transfer network, in which there is no notion of clients or servers, but only equal peer nodes that simultaneously function as both “clients” and “servers” to the other nodes on the network (This model of network arrangement differs from the client-server model where communication is usually to and from a central server.). In addition, a P2P network could also be a hybrid network in which a client-server structure is used for some tasks (e.g., searching), and a peer-to-peer structure for others.

II. System Overview

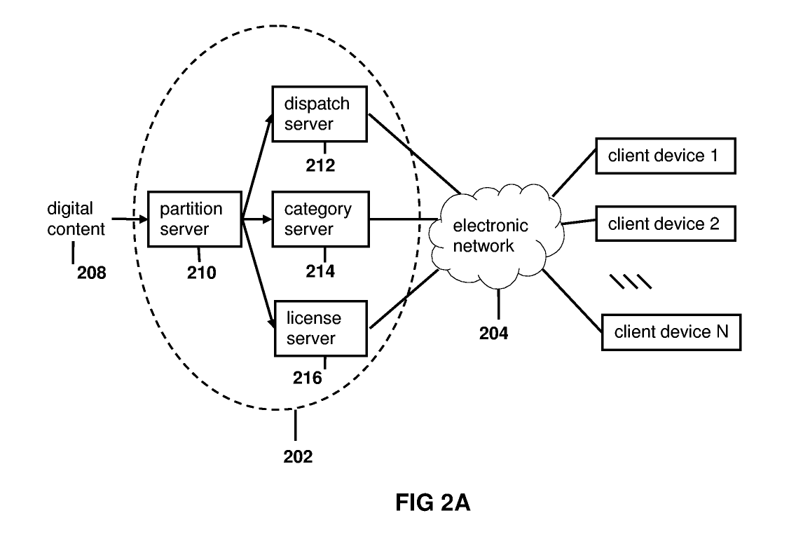

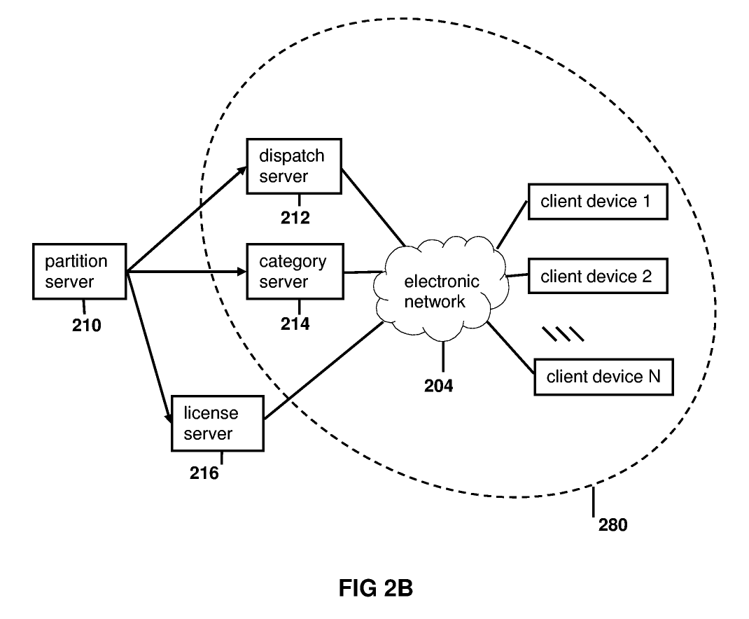

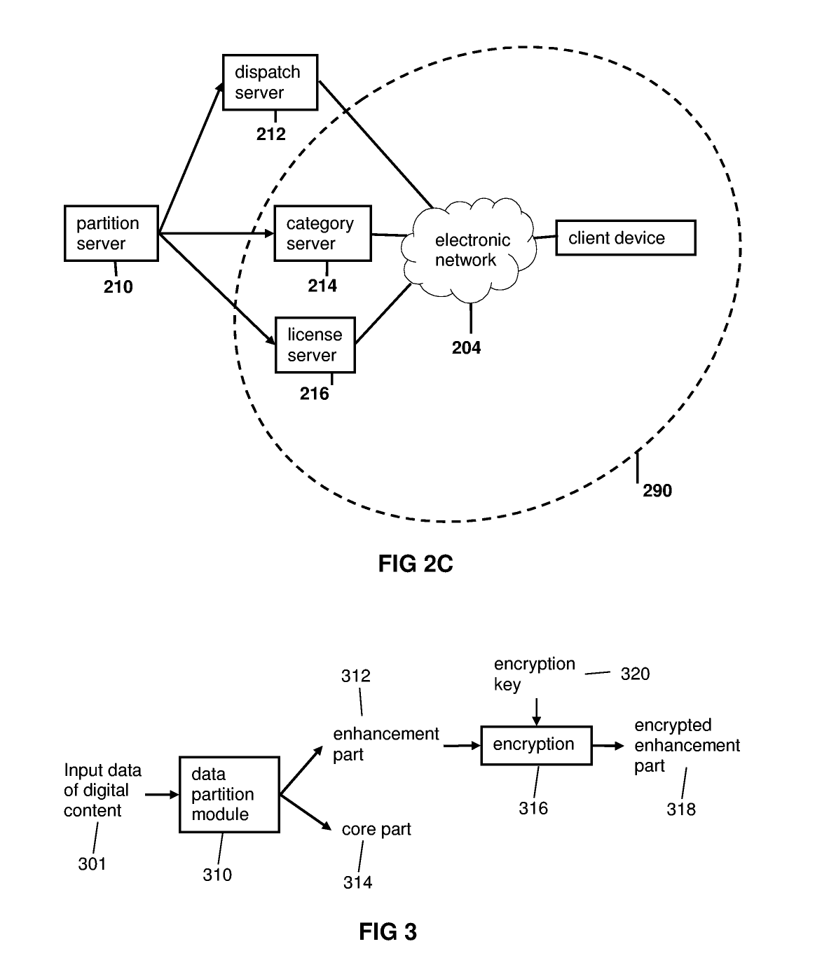

Referring to FIG. 2A, in one embodiment, a digital content distribution system comprises a set of servers 202 operated by the service provider, an electronic network 204, and a plurality of client devices. The servers 202 further include a partition server 210, a dispatch server 212, a category server 214, and a licensing server 216.

The electronic network 204 provides data communication capacities for the servers and the client devices (one individual server may communicate with other servers and/or client devices, and one client device may communicate with other client devices and servers). It could be an open network such as Internet, and it could also be any private network of similar capacities.

The partition server 210 processes digital content 208, and partitions each title of digital content into at least two parts: at least one enhancement part and at least one core part. The partition server 210 sends the enhancement parts to the dispatch server 212, and the core parts to the licensing server 216. In addition, the partition server 210 also compiles a category of titles and sends it to the category server 214.

A client device (one out of the N as shown in FIG. 2A) communicates with the category server 214 to get a copy of the category. A user (not shown) browses the category over the client device, selects a title. The at least one enhancement part representing the selected title is distributed to the client device through an enhancement part distribution sub-system, and the at least one core part representing the selected title is distributed to the client device separately through a core part distribution sub-system. When the client device gets all of the enhancement part(s) and the core part(s) belonging to the selected title, it further assemblies the multiple parts to recover the original data representing the title.

In one embodiment, an enhancement part distribution sub-system includes a category server 214, a dispatch server 212, one or more client devices, and an electronic network 204. A core part distribution sub-system includes a licensing server 216, a client device, and an electronic network 204. FIG. 2B and FIG. 2C show the structures of an enhancement part distribution sub-system and a core part distribution sub-system according to this embodiment respectively. Note that the components in FIG. 2B and FIG. 2C represent different grouping of the same components shown in FIG. 2A. In other words, FIG. 2B and FIG. 2C represent two different functional sub-systems of FIG. 2A. More details about enhancement part distribution sub-system and core part distribution sub-system will become apparent in later descriptions.

Referring back to FIG. 2A, in one embodiment, at least one enhancement part and at least one core part are encrypted. A client device needs to get the decrypting information from a licensing server 216 in order to decrypt and assembly multiple parts to reconstruct the digital content.

III. PARTITION SERVER

FIG. 3 shows an exemplary flow diagram of an embodiment of partition server data processing procedure. Input data of a digital title 301 is first processed by a data partition module 310 and is partitioned into two parts: an enhancement part 312 and a core part 314. The enhancement part 312 is further encrypted by encryption module 316, generating encrypted enhancement part 318. In one embodiment, a symmetric encryption algorithm such as DES (Data Encryption Standard) is used to encrypt 312.

Referring back to FIG. 2A, after data partition and encryption, a partition server 210 sends encrypted enhancement part 318 to a dispatch server 212, sends encryption key 320 and core part 314 to license server 216, and category information of the processed title to category server 214. In operation, enhancement part 318 and core part 314 are distributed to a client device through different methods, and assembled by a client device into a presentable form.

IV. Data Patition and Assembly Method

Referring to FIG. 3, the data partition module 310 could be designed using several different data processing methods. However, the basic requirements that such a data processing method has to meet include: (1) enhancement part 312 is much bigger than core part 314; (2) enhancement part 312 is of no or limited value to a client when core part 314 is missing; (3) enhancement part 312 and core part 314 could be assembled through some processing to recover the original digital content 301.

A. Frame Filtering Method

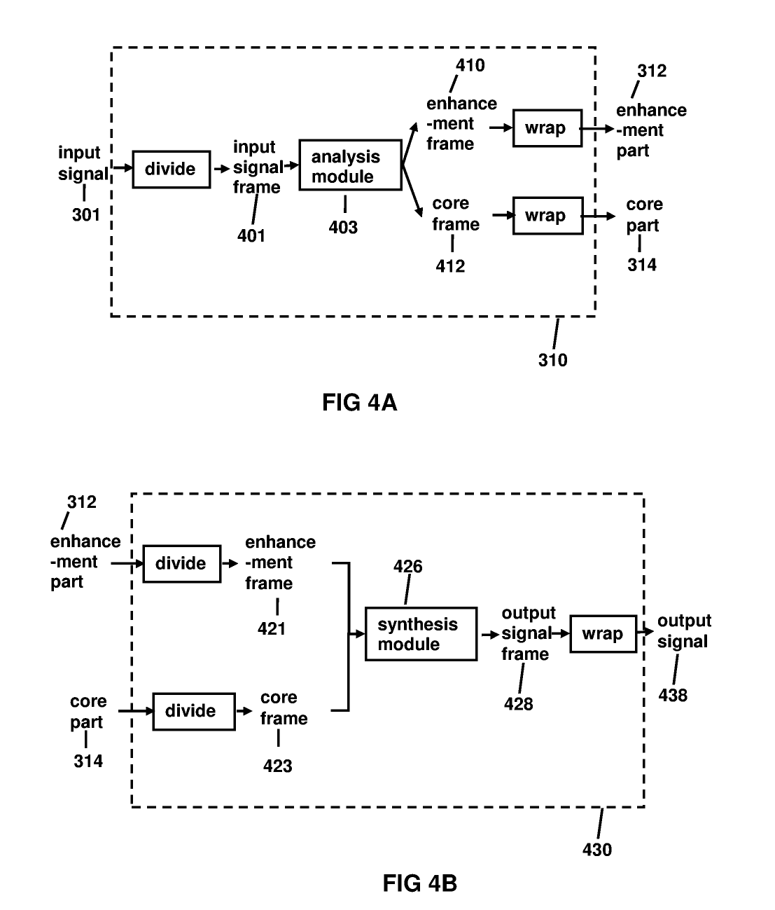

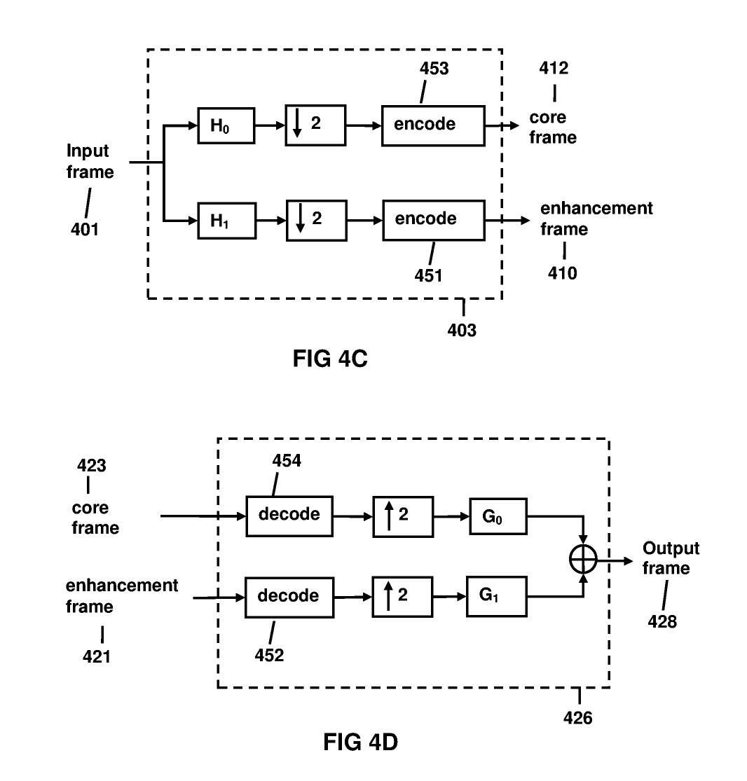

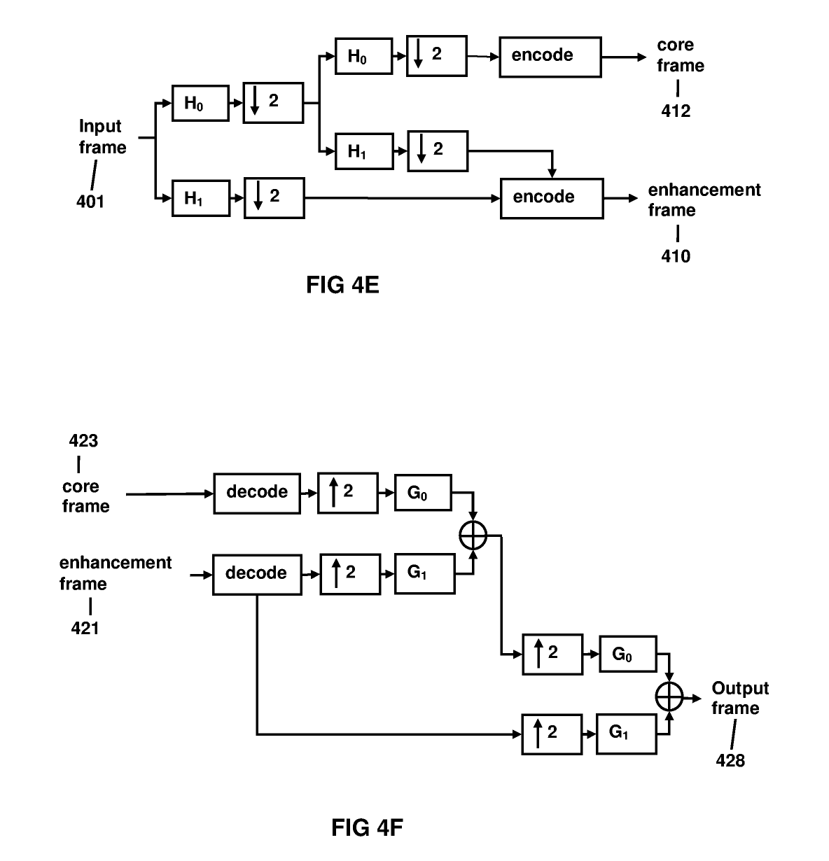

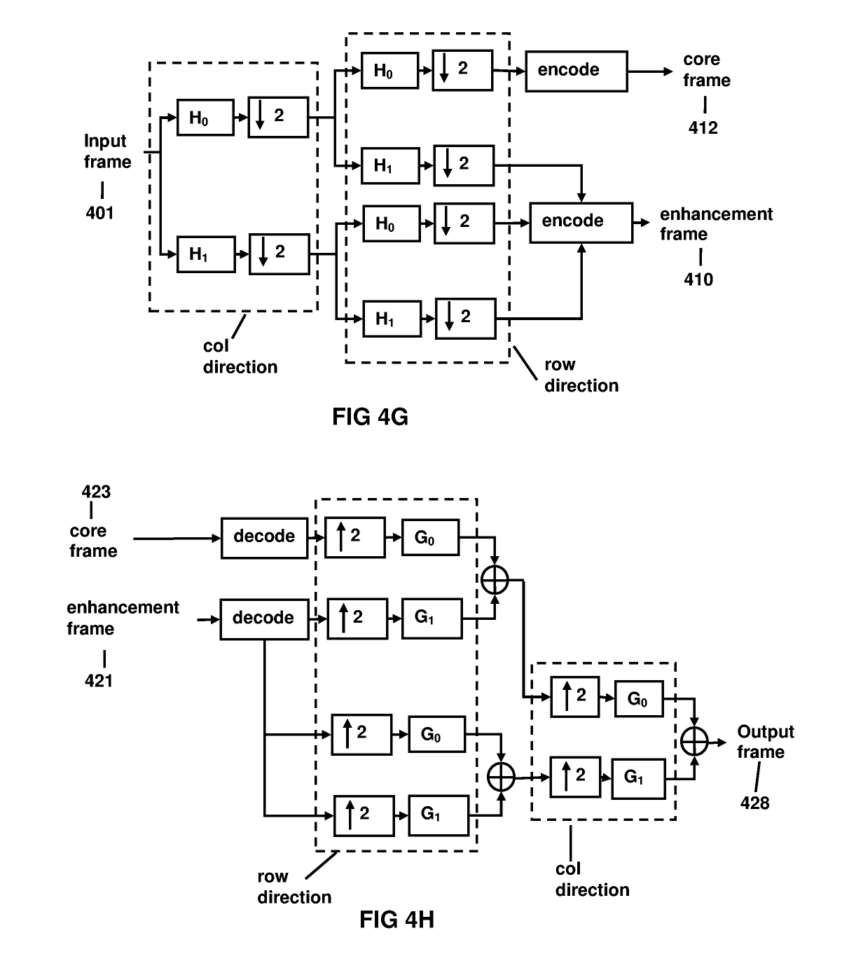

Referring to FIG. 4A, in one exemplary embodiment, a data partition module 310 is implemented using a frame filtering method. According to this method, digital signal representing a title 301 in uncompressed form is first divided temporally into multiple frames 401. For digital audio, frame 401 is a one-dimension data array; while for digital video, frame 401 is a two-dimension data array. Frame 401 is processed and separated by an analysis module 403 into two parts: enhancement frame 410 and core frame 412. Multiple enhancement frames 410 and core frames 412 are further wrapped up respectively into enhancement part 312 and core part 314.

FIG. 4B shows a corresponding data assembly module 430 that assembles the enhancement part and the core part generated by data partition module 310 shown in FIG. 4A. First, the enhancement part 312 and the core part 314 are divided and/or unwrapped respectively into individual enhancement frames 421 and core frames 423. Each enhancement frame 421 and its corresponding core frame 423 are processed by synthesis module 426 to generate an output frame 428. Multiple signal frames 428 are further wrapped up by a wrapping module to form output signal 438.

Referring to FIG. 4B, in the distribution system as proposed by the present invention, the actual data assembly module 430 is implemented on client devices, which will be explained in more detail in later descriptions. Here we describe some embodiments of assembly module 430 together with partition module 310 because they have to be designed together so that module 430 could successfully assembly core parts and enhancement parts generated by module 310.

Referring to FIG. 4A and 4B, with frame dividing modules and frame wrapping modules, the design of partition module 310 and assembly module 430 boils down to the design of analysis module 403 and synthesis module 426. In some embodiments, the analysis module 403 in FIG. 4A and the synthesis module 426 in FIG. 4B are designed together so as to make sure that the enhancement frames and the core frames generated by analysis the module 403 could be assembled by the synthesis module 426.

In one embodiment, the analysis module 403 and the corresponding synthesis module 426 are designed using Wavelet filter banks. FIG. 4C and FIG. 4D show the flow charts of module 403 and module 426 according to the embodiment respectively.

Referring to FIG. 4C, input frame 401 is processed by a pair of Wavelet analysis filters H0 and H1 respectively, followed by down-sampling modules that down-samples the signal by two, and encoding modules that encode the down-sampled signal into core frame 412 and enhancement frame 410 respectively. Note in the filter bank pair, filter H0 is the low-pass filter and is used to generate core frame 412. H1 is the high-pass filter and is used to generate enhancement frame 410. The functions of encoding modules 451 and 453 may include entropy coding that are specifically designed for enhancement frames and core frames respectively.

Referring to FIG. 4D, a core frame 423 and the corresponding enhancement frame 421 are respectively processed by a decoding module, then up-sampled by two. The up-sampled signals are further filtered by synthesis filters G0 and G1 respectively. The output of the filters G0 and G1 are added up to generate an output frame 428. In FIG. 4D, the decoding modules 452 and 454 works for core frame 423 and enhancement frame 421 respectively. The function of module 452 is the inverse of module 451, and module 454 is the inverse of module 453.

Referring to FIG. 4C and 4D, in order to make sure that the synthesis module 426 in FIG. 4D will correctly assembly enhancement frames and core frames generated by the analysis module 403 in FIG. 4C, the filters H0, H1 and G0 and G1 have to certain conditions. For example, H0 and H1 could be a pair of Haar Wavelet analysis filters and G0 and G1 could be the corresponding Haar Wavelet synthesis filters.

In some other embodiment, the analysis filter banks and the synthesis filter banks shown in FIG. 4C and 4D could be stacked up to generate analysis modules and synthesis modules that realize different partitions between a core frame and an enhancement frame. FIG. 4E and 4F show the flow charts of the analysis module and the synthesis module of one of such embodiments respectively.

Referring to FIG. 4E, input frame 401 is first processed by a pair of filters H0 and H1 (followed by sub-sampling modules). The output of filter H0, i.e., the low-pass part of the signal is further processed by a second pair of filters H0 and H1 (followed by sub-sampling modules). The output of the second low-pass filter is encoded by an encoding module to generate a core frame 412. The output of the first and the second high-pass filters are merged and encoded by encoding module to generate an enhancement frame 410.

Referring to FIG. 4F, corresponding to the analysis module shown in FIG. 4E, the core frame 423 and enhancement frame 421 are processed by two stacked stages of filter banks of synthesis filters G0 and G1.

In some further embodiment, an input frame of an analysis module is two-dimension data array (e.g., an image). The same filter banks used in FIG. 4C and FIG. 4D could be applied twice sequentially, first along the column direction, then along the row direction. FIG. 4G and FIG. 4H show the flow charts of the analysis module and the synthesis module according to this embodiment respectively. Referring to FIG. 4G, the analysis filter banks H0 and H1 are first applied to the input frame 401 along the column direction, and then applied to the output signals along the row direction respectively. The low-pass output generated along the path ( H0 (col), H0 (row) ) is encoded as the core frame 412, while the rest are merged and encoded as the enhancement frame 410. The flow chart of FIG. 4H just process the core frame 423 and the enhancement frame 421 in the reverse order: first processed by a synthesis pair G0 and G1 along the row direction, then along the column direction.

B. Bit Stream Parsing Method

In another exemplary embodiment, a data partition module 310 is implemented using a bit stream parsing and manipulation method. According to this method, the input data 301 shown in FIG. 3 is considered to be a compressed bit stream (e.g., MPEG-1 bit stream). Without fully decoding the bit stream, a data partition module 310 processes the compressed bit stream directly to partition a title into two bit streams: an enhancement bit stream and a core bit stream, each representing the enhancement part and the core part of the title respectively.

In one embodiment, input data 301 of a data partition module 310 is MPEG-1 video bit stream. A partition module 310 is implemented as two separate sub-modules: an enhancement part processing module 310-1 and a core part processing module 310-2.

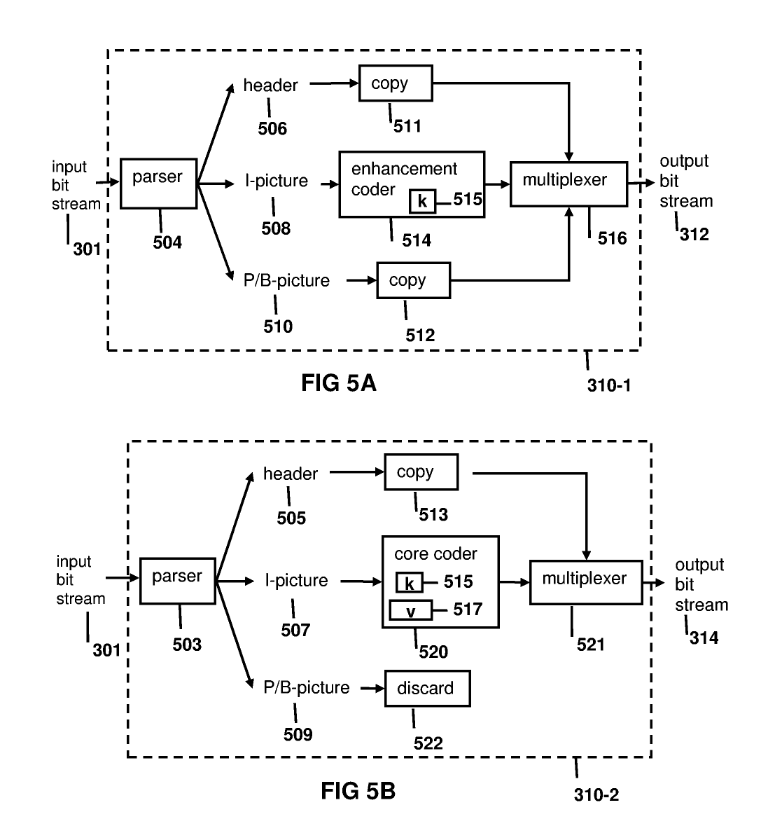

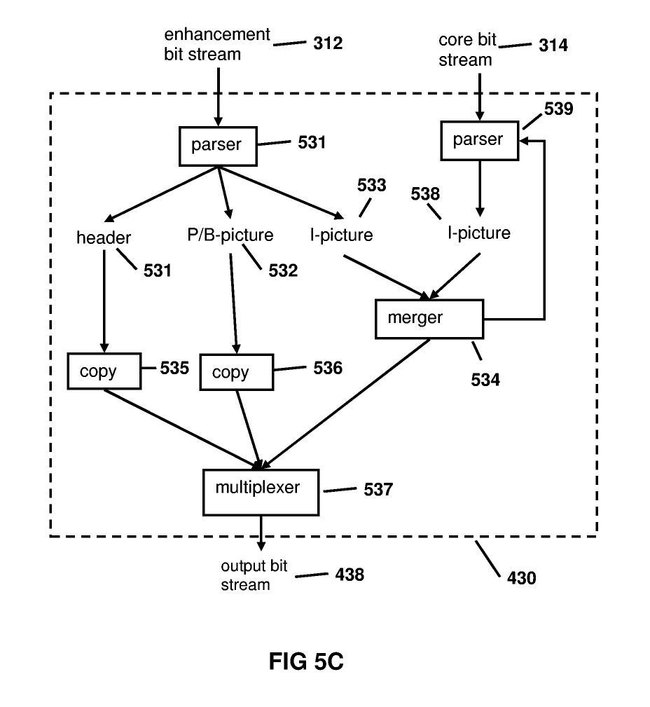

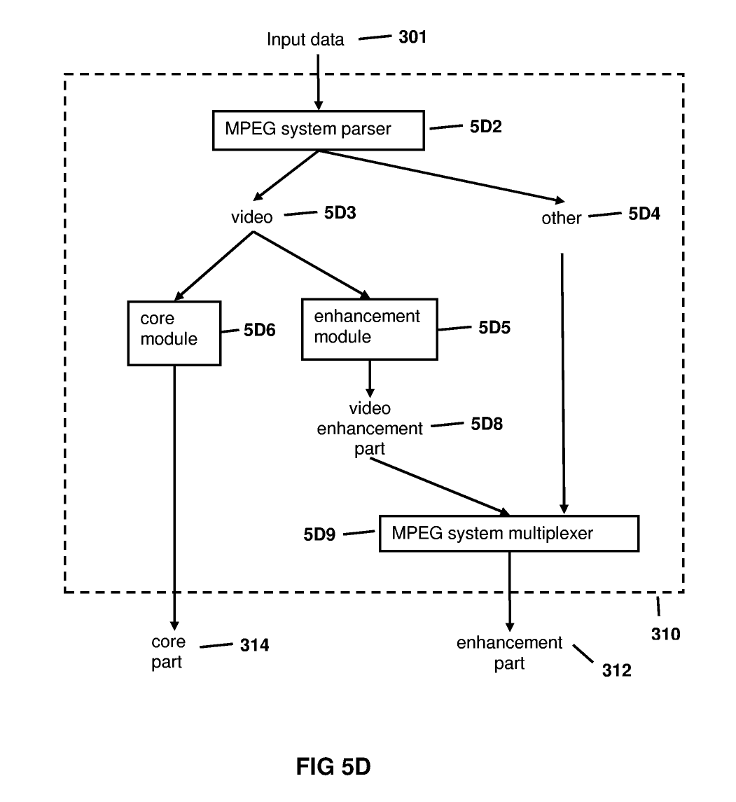

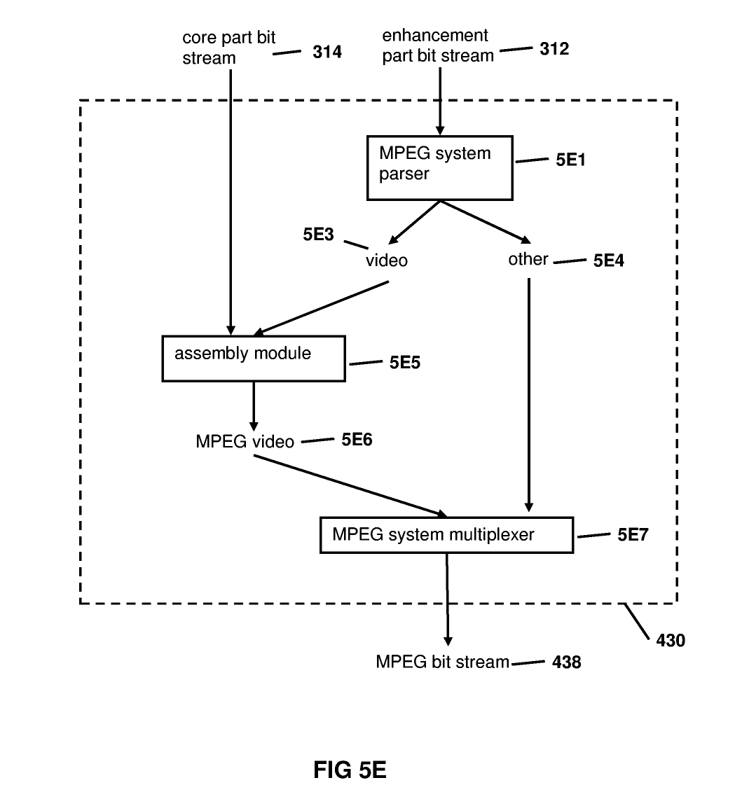

Referring to FIG. 5A, an exemplary processing procedure is depicted for enhancement part processing module 310-1. As indicated, input bit stream 301 is assumed to be a MPEG-1 video stream conforming to MPEG-1 video syntax. More details about MPEG-1 video standard, including bit stream syntax and MPEG-1 terminology are described in “MPEG video compression standard”, J. Mitchell et al., published by Kluwer Academic Publishers, 1996, which is incorporated herein as reference. A parser module 504 processes the input bit stream 301, and decomposes it into three types of components: header 506,I-picture 508 and P-/B-picture 510. Since MPEG-1 video syntax includes a plurality of component layers such as: video sequence, group of picture (G0P), picture, slice, macroblock and block, here header 506 refers to any header and end code that are above (but not including) picture layer, which essentially refers to video sequence and group of picture layers.

In FIG. 5A, copy modules 511 and 512 have the same function: they simply copy bits from input to output. A multiplexer module 516 copies bits from one of its input to output. Module 516 selects its input based on the status of parser 504, whose function is a demultiplexer. For example, when the output of parser 504 is header 506, module 516 will copy header 506 to output bit stream. When the output of parser 504 is I-picture 508, module 516 will then copy output of enhancement encoder 514 to the output bit stream.

For header 506, a copy module 511 copies its bits directly to output bit stream through a multiplexer module 516. Similarly, a P-picture or B-picture 510 is also copied directly to output bit stream through a copy module 512. The only component modified is I-picture 508, which is processed by an enhancement coder module 514.

In operation, an enhancement coder module 514 processes an I-picture 508 by removing DC components from a number of macroblocks. DC components are removed because from signal coding point of view, DC components are much more important than AC components. When DC components are missing, an I-picture will not decode correctly. Consequently, since P-pictures and B-pictures are inter-coded based on I-pictures, they will not decode correctly neither. The rational of this operation is therefore to single out the part of the input data (DC components) that are most important for playing back the digital content and hide them in the core part, but leave the rest of the data as the enhancement part.

According to MPEG-1 video syntax, an I-picture may contain several slices and within each slice the DC values of luminance components and chrominance components of each block are differentially encoded respectively. Therefore, an exemplary design of module 514 is to set the DC components of the first k macroblocks of every slice to a constant, where k (parameter 515) is an integer parameter whose determination will be described in more details later. This way, the DC components of the whole I-picture will not decode correctly since the differential coding used. According to MPEG-1 bit stream syntax, this exemplary design could be easily implemented by parsing and modifying the MPEG-1 bit stream directly. In addition, the design of the enhancement coder 514 also makes sure that the rest of the bits representing the I-picture are not modified. Therefore, the output bits from coder 514 still represent a valid MPEG I-picture bit stream, except that the DC components of some blocks are set to a constant. As shown in FIG. 5A, the output bits of 514 are copied to the output bit stream 312 through a multiplexer 516. When multiplexer 516 copies bits to output stream 312, the original bit order is maintained. Therefore, the output bit stream 312 is still a valid MPEG-1 video stream. The only difference between input bit stream 301 and bit stream 312 is that some DC components on each I-picture are set to a constant on bit stream 312.

Referring to FIG. 5B, an exemplary processing procedure is depicted for core part processing module 310-2. This processing procedure is designed to work together with the enhancement part processing procedure depicted in FIG. 5A. As shown in FIG. 5B, an input MPEG-1 video bit stream 301 is processed by a parser 503, and separated into three types of components: header 505, I-picture 507 and P/B-picture 509. Header 505 is copied directly to output stream by a copy module 513 through a multiplexer 517. P/B-picture 509 is discarded, and I frame 507 is processed by core coder 520.

Note in FIG. 5B, copy module 513 has the same function as modules 511 and 512 in FIG. 5A; parser 503 hast the same function as parser 504 in FIG. 5A; multiplexer 521 has the same function as multiplexer 516 in FIG. 5A. In addition header 505 is the same data type as header 506 in FIG. 5A, I-picture 507 is the same data type as I-picture 508 in FIG. 5A, and P/B-picture 509 is the same data type as P/B picture 510 in FIG. 5A.

In one embodiment, core coder 520 is designed to keep the DC components that are removed by enhancement coder 514 as shown in FIG. 5A. As indicated in FIG. 5B, coder 520 is controlled by two parameters: k parameter 515 and v parameter 517, where k is an integer indicating that core coder 520 has to keep the DC components of the first k macroblocks of each slice in an I-picture, and v parameter 517 is a binary-valued flag whose determination will become clear in later descriptions. One exemplary design of coder 520 is to modify I-picture bit stream 507 directly as follows: (1) If v parameter 517 is set, copy the I-picture bit stream 507 directly to output bit stream 314 through multiplexer 521. (2) Otherwise, encode only the first k macroblocks of each slice, and use MPEG video syntax to skip other macroblocks. For the macroblocks that are encoded, encode only the DC components and skip AC components by following MPEG video syntax. According to MPEG-1, an I-picture is not allowed to skip macroblocks, therefore the output bit stream from coder 520 is no longer a valid MPEG-1 I-picture bit stream. Accordingly, the final output bit stream 314 is no longer a valid MPEG-1 video bit stream when macroblock skipping is applied. However, a customized parser built on top of basic MPEG-1 video syntax will have no problem parsing bit stream 314. This customized parser could be built such that it follows MPEG-1 video syntax except that macroblock skipping is allowed for I-pictures.

Referring to FIG. 5A and FIG. 5B, k parameter 515 determines the number of DC components removed from enhancement part and moved to core part, and therefore determines the final sizes of enhancement bit stream 312 and core bit stream 314. When a targeted size of bit stream 314 is determined, k parameter 515 can be determined accordingly. In one exemplary design, input bit stream 301 represents MPEG-1 Video of 720 by 480 pixels resolution, and there are 1350 macroblocks in each I-picture, and 675 in each slice when there are two slices per I-picture. k parameter 515 is set to be 14 in this situation so that only about 1/50 of the macroblocks on each I-picture are represented in the core bit stream 314. If further considering that the AC components are removed and the P/B-pictures are removed by coder 520, the size of bit stream 314 will be smaller than 1/100 of size of input bit stream 301. Accordingly, if the bit rate of input stream 301 is 1.8 Mbits/sec, the bit rate of bit stream 314 will be about 18 Kbits/sec, which is well within the bandwidth of many today's Internet users.

Referring again to FIG. 5B, v parameter 517 determines whether an I-picture is processed or not. In one embodiment, v parameter 517 is set to be zero for every I-picture, and therefore every I-picture is processed by removing AC components and skipping macroblocks. In another embodiment, v parameter 517 is set to one for about 1/100 of the I-pictures, and zero for the rest. Setting v=1 is mainly intended to keep some full I-pictures (with all of the AC components and macroblocks) in core bit stream 314 so that digital watermark can be added to these I-pictures later in the distribution system. More details about digital watermarking and distribution will become apparent in later descriptions.

FIG. 5C shows data assembly procedures to assembly the enhancement part and the core part generated from procedures depicted in FIG. 5A and FIG. 5B respectively. As indicated in FIG. 5C, the enhancement part bit stream 312 is processed by a MPEG parser 531, and demultiplexed into three parts: header 531, P/B-picture 532 and I-picture 533. Header 531 and P/B-picture 532 are copied directly to the output bit stream. I-picture 533 is processed by merger module 534. In operation, merger module 534 controls parser 539 to parse core part bit stream 314 and find the I-picture 538 in bit stream 312 that belongs to the same G0P and same temporal picture order as I-picture 533. As described above, bit stream 312 is a MPEG-1 compliant video stream except that macroblock skipping is used in I-pictures. Therefore it is easy to implement a customized parser 539 to find I-picture 538 that corresponds to I-picture 533. Multiplexer 534 merges I-picture 538 with I-picture 533 by the following procedure: (1) If I-picture 538 contains AC components, copy 538 directly to output, discard I-picture 533. (2) Otherwise, copy the DC components in I-picture 538 to the corresponding blocks in I-picture 533, which produces an I-picture that is further copied to output bit stream 438 through multiplexer 537. The final output bit stream 438 is a MPEG-1 video bit stream containing all the necessary information for decoding and display.

Note in the distribution system as proposed by the present invention, the actual data assembly module 430 shown by FIG. 5C is implemented on client devices, which will be explained in more detail in later descriptions.

Referring back to FIG. 3, in a further embodiment, input data 301 of a data partition module 310 is a MPEG-1 system bit stream comprising at least one MPEG-1 video stream and at least one other stream, such as audio stream. FIG. 5D shows an exemplary flow diagram of data partition module that handles MPEG-1 system bit stream. Input data 301 is first processed by a MPEG system parser 5D2 and is separated into two parts: a MPEG-1 video stream part 5D3 and an “other” part 5D4. Here “other” part includes all the streams in input 5D1 other than 5D3. Video stream 5D3 is further processed by two modules: an enhancement processing module 5D5, and a core processing module 5D6, which separate 5D3 into two parts: core part 5D7 and video enhancement part 5D8. One exemplary design of module 5D5 and 5D6 is depicted in FIG. 5A and FIG. 5B respectively. Based on design described in FIG. 5A, part 5D8 is still a valid MPEG-1 video bit stream, therefore 5D8 could be multiplexed by a MPEG multiplexer 5D9 with other MPEG streams (part 5D4) into a MPEG system stream 312, which serves as the enhancement part output of the system.

Referring to FIG. 5E, an exemplary flow diagram of data assembly module 430 corresponding to the data partition module shown in FIG. 5D is depicted. As indicated, enhancement part 312 is demultiplexed by MPEG system parser 5E1 into a video stream 5E3 and an “other” stream part 5E4. Video stream 5E3 is merged with core part stream 5E1 by a video data assembly module 5E5 (note one exemplary design of 5E5 is shown in FIG. 5C, with input 312 in FIG. 5C replaced by input 5E3 in FIG. 5E), generating a MPEG-1 video stream 5E6. Finally, bit stream 5E6 is multiplexed with 5E4 by a MPEG system multiplexer 5E7, generating a MPEG system bit stream 438. According to this design, bit stream 438 is a valid MPEG-1 system bit stream and is ready for a standard MPEG-1 decoder to decode and play back the digital content.

Comparing FIG. 5E with FIG. 5C, one can notice that data assembly module 5E5 utilizes module 430 shown in FIG.5C. More specifically, assembly module 5E5 in FIG. 5E is equivalent to module 430 in FIG.5C.

Note here although only processing modules for MPEG-1 bit stream are described, the design of corresponding modules for other bit streams such as MPEG-2, MPEG-4, etc., will be straightforward for one of ordinary skill in the art.

V. Enhancement Part Distribution Sub-system

Referring to FIG. 2B, an exemplary enhancement part distribution sub-system comprises a dispatch server 212, an electronic network 204, and a plurality of client devices. Within this sub-system, enhancement parts of digital content are distributed in a peer-to-peer model and/or a client-server model.

Since an enhancement part alone is of no or limited value to a client, DRM in the enhancement part distribution sub-system does not have to be as strong as that in the core part distribution sub-system. Generally, many different peer-to-peer systems and methods known in the art could be used for enhancement part distribution. For example the Napster distribution method could be used for this purpose. In addition, a peer-to-peer system without any central server such as Kazaa program could also be used.

In one embodiment, an enhancement part distribution process is initiated by a client device when it starts an enhancement part download session. During the download session, the client device obtains a copy of the encrypted enhancement part (FIG. 3, 318) belonging to the requested title from dispatch server 212 and/or one or more other client devices.

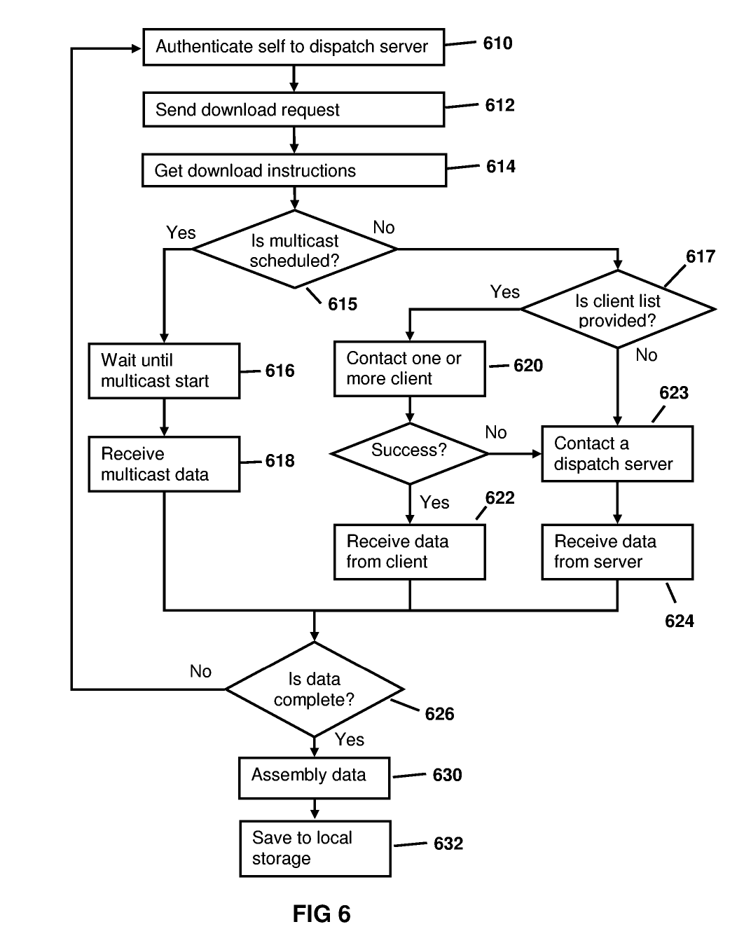

Referring to FIG. 6, an exemplary flow diagram of an embodiment is depicted for a client device enhancement part download session. As a first step, a client device first authenticates self to a dispatch server (step 610), and sends download request to the dispatch server (step 612). The client device then gets download instruction from dispatch server (step 614). Based on the download instruction, the client device may arrange its download procedure to get requested data as follows: (1) If the request title is a popular title and the dispatch server has scheduled a multicast of it (checked in step 615), the download session may switch into a waiting mode to wait until the multicast starts (step 616), and then start to receive at least part of multicast data (step 618). (2) Otherwise, if a list of other client devices are provided by the dispatch server (checked in step 617), the client device may contact one or more of these client devices (step 620), and attempt to get at least part of the requested data from one or more of these other client devices (step 622). (3) If no client device list is provided, or none of the client devices listed could be contacted, the client device may contact the dispatch server (step 623) and attempt to get at least part of the requested data (step 624). Within a download session, downloaded data is monitored for completeness periodically (step 626). If data is not complete, the process flow goes back to step 610. Otherwise, the received enhancement part is assembled (step 630), and saved to local storage (step 632). After that the session is finished. Note by default a client side enhancement part download session will save downloaded enhancement parts on local storage so that they can be shared with other client devices.

In step 614, a dispatch server provides download instructions by compiling a list of the available titles, and associated with each title, a list of client devices that have a copy of the enhancement part. For each request, the dispatch server may send back a random subset of the full list associated with the requested title, or a subset of the list of the client devices that are located closer to the requesting client device. In addition, the dispatch server also keeps a record of most popularly requested titles and may schedule a multicast when necessary. By using multicast, a popular title can reach multiple client devices in a very efficient way because only one copy of the data is sent over network, and duplicated traffic is avoided.

In one embodiment, encrypted enhancement part (FIG. 3, 318) is distributed in a number of smaller chunks. Each chunk is attached with a hash code which a receiver can use to verify the integrity of the chunk. Therefore in step 622, a client device may contact multiple other client devices to get different chunks from different client devices. In addition, in step 626, a client device checks the integrity of the downloaded file by checking each downloaded chunk, and the process goes to step 610 only when some chunks are missing. In this situation, only the missing chunks are requested in the new processing starting from step 610.

In some other embodiment, the distribution of the enhancement parts is carried out by storing the enhancement parts on some non-volatile media (e.g., DVD), and shipping the media to the users. According to this embodiment, a user may insert the media into a client device to finish enhancement part distribution. However, in order to play back the content, the client device has to go through the core part distribution sub-system to acquire the corresponding core part(s).

VI. Core Part Distribution Sub-system

Referring to FIG. 2C, an exemplary embodiment of a core part distribution sub-system comprises a license server 216, an electronic network 204, and a client device. Within this sub-system, core parts of digital content are distributed in a client-server model. In other words, a client device communicates directly with license server 216 to get core parts.

In one embodiment, the operation of core part distribution involves two sessions: a client side core part session running on a client device and a server side core part session running on a license server. The distribution process starts when a client side session starts. On receiving the request from the client session, a server side session is started to address the request.

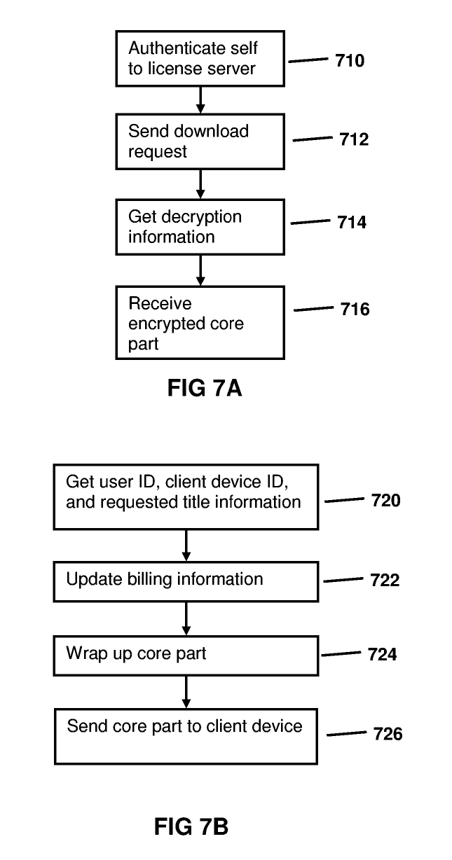

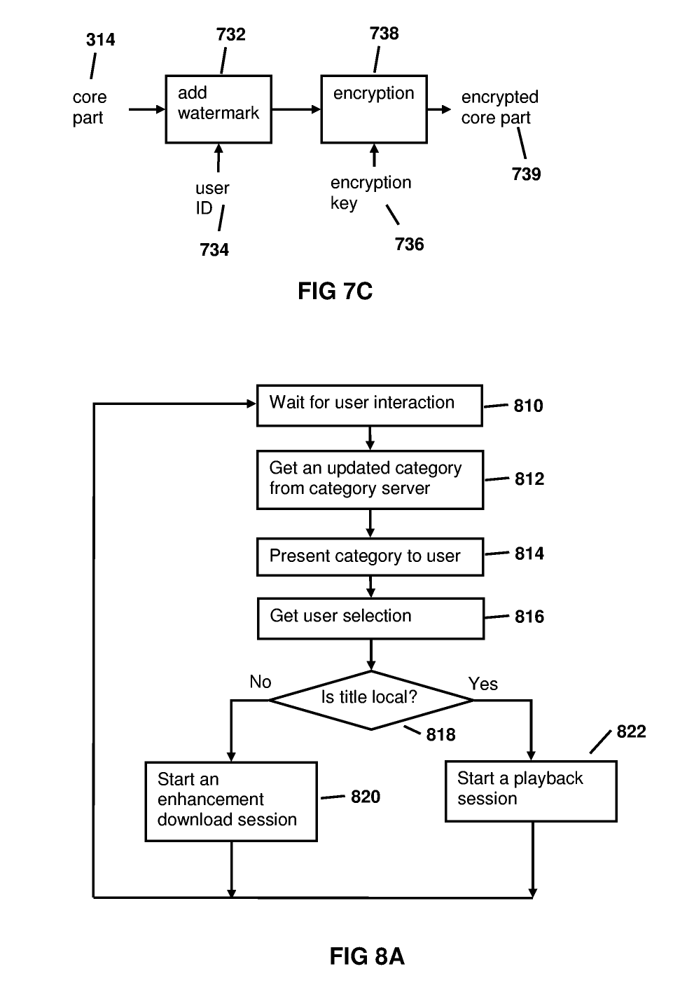

FIG. 7A shows an exemplary flow diagram of a client side core part session. In a client side session, a client device first authenticates self to the license server (step 710). Then the client device sends download request to the license server, indicating which title, and what DRM is requested (step 712). In step 714, the client device obtains decryption keys from the license server. In step 716, the client device starts receiving encrypted core part data (FIG. 7C, 739).

Referring to FIG. 7B, an exemplary flow diagram of a server side core part session is depicted. In the first step (step 720), the license server gets the user ID, the client device ID, and the requested title information from the client device. Next, the license server updates the billing information associated with the user ID (step 722). In step 724, the license server wraps up the core part being requested based on the user ID and client device ID. In step 726, the license server sends the wrapped core part to the client server.

Referring to FIG. 7C, a block diagram of an embodiment of a core part wrapping module (used in a sever side session step 722, FIG. 7B) is depicted. Core part 314 is first processed by watermarking module 732, which embeds the user ID information 734 to the core part. Next, an encryption module 738 encrypts the core part using an encryption key 736. A symmetric encryption algorithm such as DES (Data Encryption Standard) can be used for the design of encryption module 738. The final output is encrypted core part 739, which is the data a client device receives in step 716, FIG. 7A.

Referring to FIG. 7C, in one embodiment, the encryption key 736 is specifically designed for different users and client devices. For example, key 736 could be derived from either or both the user ID 734 and the client device's ID information. This way, the encrypted core part 739 can only be used the specific user on specific client device.

Referring to FIG. 7C, in one embodiment, core part 314 is generated by a MPEG bit stream parsing method as described in Section III-B. Then watermarking module 732 employs a compressed domain watermarking algorithm to embed user ID 734 information into I-pictures in bit stream 524 that contain AC components. For this purpose, many different known algorithms in the art could be used. For example, the paper by by F. Hartung et al., titled “Watermarking of uncompressed and compressed video”, published in Signal Processing, vol. 66, no. 3, 1998 describes some compressed domain watermarking algorithm. An important benefit of module 732 is to generate a customized copy of digital content for each specific user. Therefore if any illegal copy is found later, the embedded digital watermark will reveal the identification of the user who originated the illegal copy. In addition, module 732 is very efficient to run on a license server since core part 314 represents only a very small percentage of the overall data associated with a digital title.

Referring back to FIG. 7B, in operation, a license server runs a separate server side core part session for each client device request. Since the design of data partition method makes sure that a core part represents only a small percentage of the overall data associated with a digital title, a server side session uses a very limited computation and communication bandwidth resources. Therefore it is possible for a license server to run multiple server side sessions, supporting multiple client devices. This is very important for saving system design cost.

VII. Client Device

In present invention, a client device is a computing device equipped with necessary hardware and software for content distribution functions. The functions of a client device comprises (1) interacting with a user, (2) communicating with servers, (3) communicating with other client devices, (4) assembling multiple parts of a digital content title, (5) play back a title of digital content.

In one embodiment, a client device always remains online, running two processes: a main process and a serving process, where the serving process hosts downloading requests from other client devices and the main process handles user interaction, downloading and plays back digital titles.

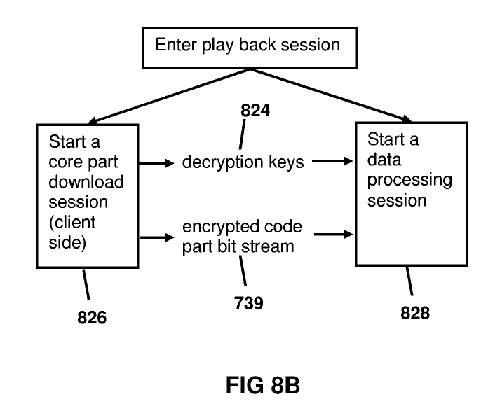

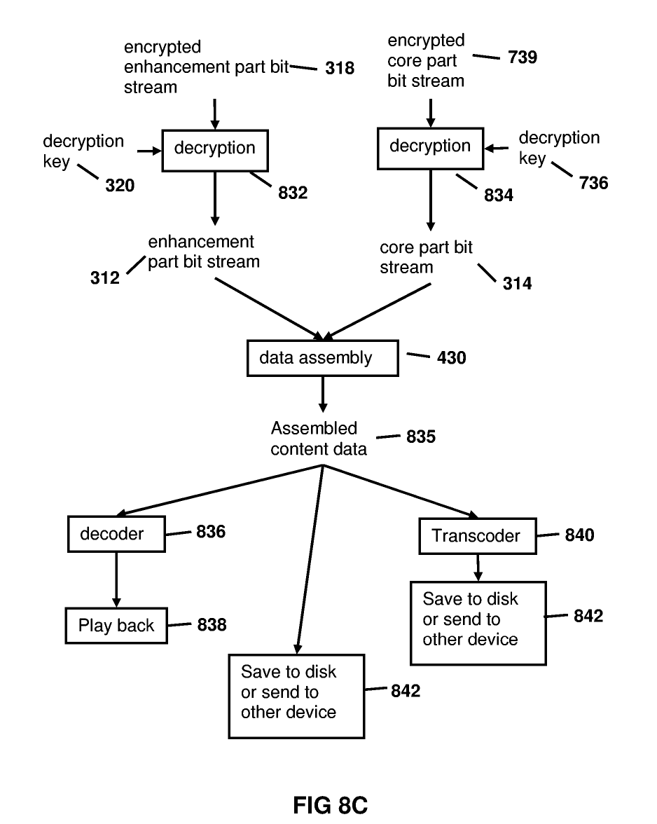

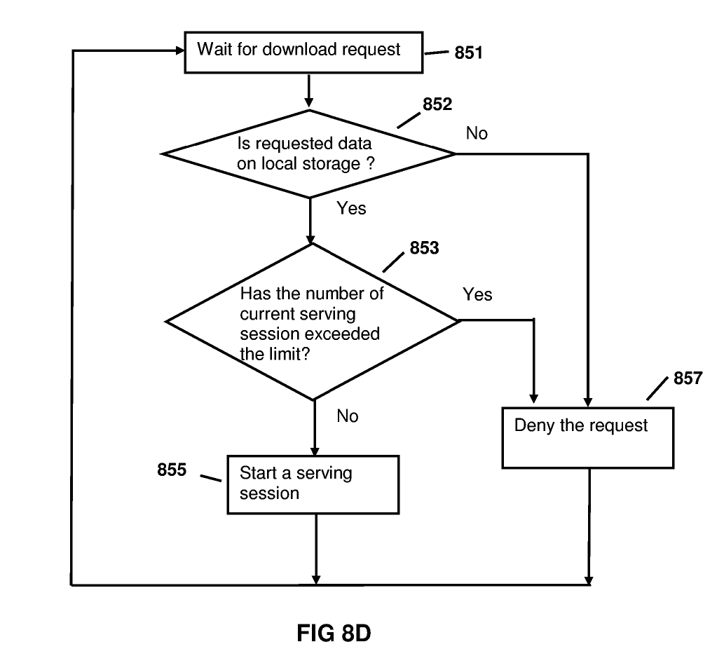

FIG. 8A depicts an exemplary flow diagram of an embodiment of a client device main process. Within a main process loop, a client device idles in step 810, waiting for user interactions. Once any user interaction received, the client device first gets an updated category of the available title from a category server (step 812). Next, the updated category is presented to the user through some user interface (step 814). In step 816, user selection is accepted. In step 818, the client device checks if the enhancement part corresponding to the user selected title is already available on local storage. If not, a new enhancement part download session is initiated (step 820). The download session will download the requested enhancement part through an enhancement part distribution sub-system. Otherwise, a new play back session is started (step 822). The play back session will download the core part through a core part distribution sub-system, assembly the data, and play it back. After step 820 or step 822, the main process goes back to step 810.

Referring to FIG. 8B, in one embodiment, a play back session further starts two sessions. First, a core part download session is started to download core part from a license server (step 826). Second, a data processing session is started to handle data assembly, decoding and play back tasks (step 828). In operation, a core part download session communicates with the license server to obtain decryption key 824 and encrypted core part bit stream 739. A data processing session takes encrypted core part bit stream 739 and encrypted enhancement part 318, decrypts both parts using decryption key 824, assembles them into data representing a valid data title, and finally playback the digital content (e.g., play back a movie over a television).

As indicated in FIG. 8B, the two sessions may run in parallel and the core part download session may stream the bits received to the data processing session which carries out data processing tasks over the received bits. In this architecture, the playback of the digital content (e.g., playback of a movie) may start before all the core part data are downloaded.

FIG. 8C further depicts one exemplary block diagram of an embodiment of a client device data processing session. As indicated, a data processing session takes as input two data streams: an enhancement part data stream 318 and a core part data stream 739. Both data streams are first decrypted by two decrypting modules 832 and 834, using decrypting key 320 and 736 respectively. Note the decrypting key 320 and 736 are provided by the core part download session as decryption key 824 in FIG. 8B. The decrypted data stream 312 and 314 are assembled by data assembly module 430. Depending on the user' choice and the DRM imposed over the digital content, the assembled content data 835 could be used by the user through multiple ways.

In some embodiment, the assembled content data 835 is directly processed by a decoder 836 and play back (module 838). A client device does not save any data from received core bit stream 739, and/or decrypted core bit stream 314, and/or assembled content data 835 on its local storage (such as hard disk or DVD ROM). This will minimize the risk of pirate copying.

In some other embodiment, the assembled content data 835 could be saved by the client device and/or sent to other devices (module 842) as long as the user uses it confirming to the DRM imposed.

In some further embodiment, the assembled content data 835 is processed by a transcoder 840 to generate a new bit stream data that is saved on local storage or further sent to other devices (module 842). Transcoder 840 may serve multiple purposes: (1) it generates a bit stream of lower resolution and lower quality than the original content data 835, so that the risk of losing the high quality data to pirate copiers is reduced. For example, a transcoder can be used to transcode a HDTV quality MPEG-2 movie to lower resolution MPEG-1 movie. (2) it may further pose a watermark signal to the new bit stream, embedding at least the user ID so that the proper use of the saved digital data could be tracked.

FIG. 8D depicts the flow chart of an embodiment of a client device serving process. Within a serving process loop, a client device idles in step 851, waiting for downloading request from other client devices. Once any download received, the client device first check if the requested data is available on its local storage (step 852). If it has the data, it will further check if the number of the current serving sessions has exceeded a maximal number (step 853). A new serving session will be started to send the requested data to the other client device that is requesting the data if every checking is fine (step 855). Otherwise the request will be denied (step 857).

What is claimed is:

1. A method for distributing digital content from a service provider to a client, comprising:
partitioning the digital content by the service provider into at least two parts: at least one core part and at least one enhancement part;
delivering the at least one enhancement part to the client over a peer-to-peer network;
submitting a core part download request to the service provider by the client;
transmitting the at least one core part to the client; and
assembling the at least one core part and the at least one enhancement part by the client.

2. The method of claim 1, further comprising authenticating the client to the service provider before transmitting the at least one core part to the client.

3. The method of claim 1, further comprising encrypting each said core part by the service provider before sending each said core part to the client.

4. The method of claim 1, further comprising watermarking each said core part by the service provide before sending each said core part to the client.

5. The method of claim 4, wherein the service provider watermarks each said core part by embedding at least the identification of the client.

6. The method of claim 1, wherein the client gets the whole or part of the data of the at least one enhancement part from a central server and/or from other clients.

7. The method of claim 1, wherein the total size of the at least one core part is much smaller than the total size of the at least one enhancement part, and at least part of the content information that is essential for properly playing back the digital content by the client is included in the at least one core part, but not included in any said enhancement part.

8. The method of claim 7, wherein the digital content is partitioned by filtering the digital content in uncompressed form.

9. The method of claim 8, wherein the digital content filtering comprises the following steps:
dividing the digital content in uncompressed form into uncompressed frames;
processing each said uncompressed frame using at least one low-pass filter, and generating a core frame;
processing each said uncompressed frame using at least one high-pass filter, and generating an enhancement frame;
assembling each said core frame into the at least one core part; and
assembling each said enhancement frame into the at least one enhancement part.

10. The method of claim 7, wherein the digital content is partitioned by processing the digital content in compressed form.

11. The method of claim 10, wherein the digital content in compressed form is a MPEG bit stream.

12. The method of claim 11, wherein the digital content partitioning comprises the following steps:
(a) parsing the input MPEG bit stream (X);
(b) composing a MPEG bit stream (Y) by setting the DC components of some of the I-picture blocks in bit stream (X) into a constant, and keeping the rest data in bit stream (X) unchanged;
(c) composing a MPEG bit stream (Z) that contains at least the DC components of bit stream (X) that were set to a constant in said bit stream (Y) composing step (b); and
(d) saving said bit stream (Y) as the at least one enhancement part and said bit stream (Z) as the at least one core part.

13. The method of claim 12, further comprising watermarking said MPEG bit stream (Z) before sending it to the client.

14. A system for distributing digital content, comprising:
a partition server configured to partition the digital content into at least two parts: at least one core part and at least one enhancement part;
a category server configured to keep category record and fulfill category download request;
at least one client device (A) configured to receive the at least one core part and the at least one enhancement part and to assembly the at least one core part and the at least one enhancement part;
an enhancement part distribution sub-system configured to deliver the at least one enhancement part to the client device (A) using a peer-to-peer method; and
a core part distribution sub-system configured to deliver the at least one core part to the client device (A).

15. The system of claim 14, wherein the total size of the at least one core part is much smaller than the total size of the at least one enhancement part, and at least part of the content information that is essential for properly playing back the digital content by the client is included in the at least one core part, but not included in any said enhancement part.

16. The system of claim 14, wherein the enhancement part distribution sub-system comprises a dispatch server configured to issue download instructions and fulfill enhancement part downloading request, an electronic network, and a plurality of client devices (B) in addition to the client device (A).

17. The system of claim 16, wherein the client device (A) gets download instructions from the dispatch server.

18. The system of claim 16, wherein the client device (A) gets the at least one enhancement part from one or more client devices of the set of client devices (B), and/or from the dispatch server.

19. The system of claim 14, wherein the core part distribution sub-system comprises a licensing server configured to record billing information and fulfill core part downloading requests.

20. The system of claim 19, wherein the licensing server encrypts the at least one core part before sending the at least one core part to the client.

21. The system of claim 19, wherein the licensing server watermarks the at least one core part before sending the at least one core part to the client.

22. The system of claim 14, wherein the partition server partitions the digital content by directly filtering the digital content in uncompressed form.

23. The system of claim 14, wherein the partition server partitions the digital content by processing the digital content in compressed form.

24. The system of claim 23, wherein the digital content in compressed form is a MPEG bit stream.

25. The system of claim 24, wherein the partition server partitions the digital content by the following steps:
(a) parsing the input MPEG bit stream (X);
b) composing a MPEG bit stream (Y) by setting the DC components of some of I-picture blocks in bit stream (X) into a constant, and keeping the rest data in bit stream (X) unchanged;
(c) composing a MPEG bit stream (Z) that contains at least the DC components of bit stream (X) that was set to a constant in said step (b); and
(d) saving bit stream (Y) as the at least one enhancement part and bit stream (Z) as the at least one core part.

26. A digital content distribution system for distributing digital content from a service provider to a client, comprising:
partitioning means for partitioning the digital content into at least two parts: at least one core part and at least one enhancement part by the service provider, wherein the total size of the at least one core part is much smaller than the total size of the at least one enhancement part, and at least part of the content information that is essential for properly playing back the digital content by the client is included in the at least one core part, but not included in any said enhancement part;
enhancement part delivery means for delivering each enhancement part to the client;
client authentication means to authenticate the client;
core part transmitting means for transmitting each core part to the client; and
assembling means for assembling the at least one core part and the at least one enhancement part.

27. The system of claim 26, wherein the enhancement part delivery means includes means for delivering each said enhancement part over a peer-to-peer network to the client.
